(19) United States
(12) Patent Application Publication
(10) Pub. No.: US 2015/0155662 A1
(43) Pub. Date: Jun. 4, 2015

(54) Center Conductor For Electrical Connector and Electrical Connector Comprising the Same

(71) Applicants: Tyco Electronics (Shanghai) Co. Ltd., Shanghai (CN); Tyco Electronics Japan G.K., Kanagawa (JP)

(72) Inventors: Doron Lapidot, Tokyo (JP); Masayuki Aizawa, Tokyo (JP); Anson Ma, Shanghai (CN)

(73) Assignees: Tyco Electronics (Shanghai) Co. Ltd., Shanghai (CN); Tyco Electronics Japan G.K., Kanagawa (JP)

(21) Appl. No.: 14/617,432

(22) Filed: Feb. 9, 2015

Related U.S. Application Data
(63) Continuation of application No. PCT/IB2013/056438, filed on Aug. 6, 2013.

(30) Foreign Application Priority Data
Aug. 9, 2012 (CN) 201220394660.9

(51) Int. Cl. H01R 24/50; H01R 12/70

(52) U.S. Cl. CPC H01R 24/50; H01R 12/7082

(57) ABSTRACT

A center conductor for a surface-mounted electrical connector is disclosed having a contacting portion, a conductor body, and a soldering portion. The contacting portion is complimentary to a contacting portion receiving space of an insulating sleeve of the electrical connector. The conductor body has a first end connected to the contacting portion. The soldering portion is connected to an opposite second end of the conductor body, having a first solder receiving groove formed on an end surface thereof, and being complimentary to a soldering pad of a printed circuit board.

### CROSS-REFERENCE TO RELATED APPLICATION

This application is a continuation of PCT International Application No. PCT/IB2013/056438, dated Aug. 6, 2013, which claims priority under 35 U.S.C. §119 to Chinese Patent Application No. 201220394660.9, dated Aug. 9, 2012.

### FIELD OF THE INVENTION

The present invention is generally related to an electrical connector, and more specifically, to a center conductor for electrical connector.

### BACKGROUND

A conventional surface-mounted RF Jack connector 100′ is shown in FIGS. 1 and 2. The connector 100′ has a center conductor 10′, an insulating sleeve 20′, and a cylindrical shielding 30′ that serves as electrical ground. The insulating sleeve 20′ is inserted into the shielding 30′ from a terminating end of the shielding 30′, and the center conductor 10′ is inserted into a central insertion bore 21′ of the insulating sleeve 20′ from the terminating end thereof.

In general, such conventional RF Jack connector 100′ is surface mounted onto a substrate such as a printed circuit board (PCB) 200′ via the center conductor 10′, as shown in FIG. 2. Specifically, the center conductor 10′ is soldered to an electrically conducting circle-shaped land, also known as “pad” (not shown), on the printed circuit board 200′ cone-shaped soldering tip portion 12′.

Since the soldering tip portion 12′ connected to the printed circuit board 200′ is cone-shaped and has a small size, and the soldering tip portion 12′ is unable to contain uniformly the excess amount of Tin during Surface Mount Soldering (“SMS”), also known as “reflow”. The overflowed Tin fillet increases the size of the soldering portion 12′, which adversely affects the impedance continuity at the soldering point, which results in a deterioration of Voltage Standing Wave Ratio (“VSWR”) at higher frequencies. An additional problem is that the land of the PCB is required to be large enough to manage the overflowed Tin fillet, adversely affecting the continuity of the impedance.

There is a need for an improved center conductor for a RF connector that would prevent the formation of an excess amount of Tin during reflow. Additionally, there is a need for an RF connector having the improved center conductor.

### SUMMARY

A center conductor for a surface-mounted electrical connector has a contacting portion, a conductor body, and a soldering portion. The contacting portion is complimentary to a contacting portion receiving space of an insulating sleeve of the electrical connector. The conductor body has a first end connected to the contacting portion. The soldering portion is connected to an opposite second end of the conductor body, having a first solder receiving groove formed on an end surface thereof, and being complimentary to a soldering pad of a printed circuit board.

### BRIEF DESCRIPTION OF THE DRAWINGS

The invention will now be described by way of example, with reference to the accompanying Figures, of which:

FIG. 1 is a perspective view of a conventional surface-mounted RF Jack connector;

FIG. 2 is an exploded view of the conventional RF Jack connector with a printed circuit board;

FIG. 3 is a perspective view of a center conductor;

FIG. 4 is a perspective view of an RF Jack connector having the center conductor;

FIG. 5 is a partial cross-sectional view of the RF Jack connector of FIG. 4.

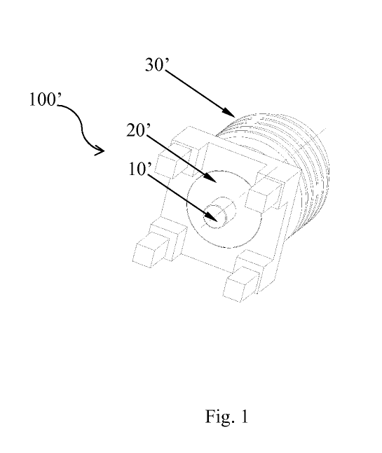

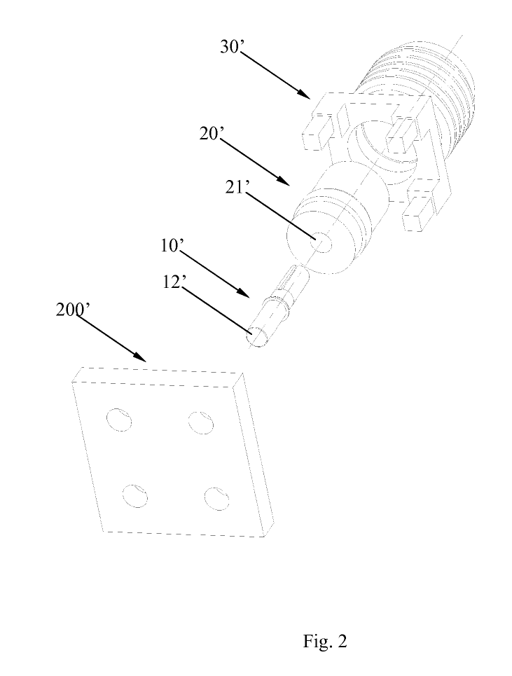

### DETAILED DESCRIPTION OF THE PREFERRED EMBODIMENTS

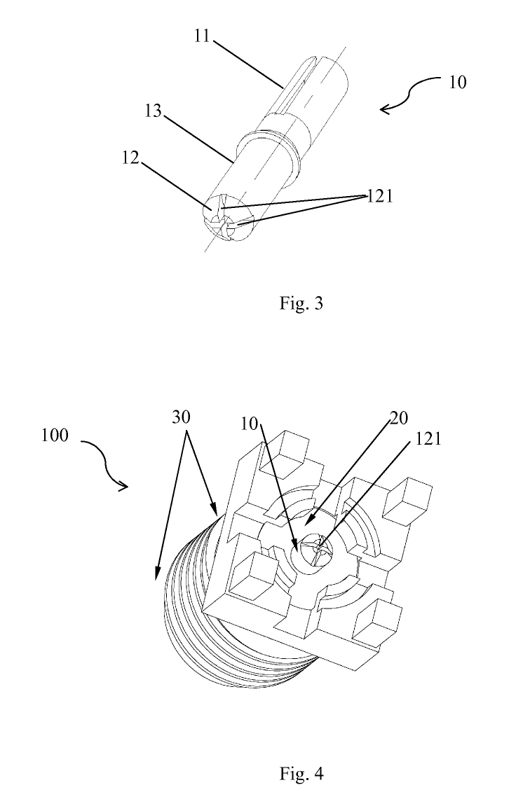

While the invention will be herein described in terms of exemplary embodiments, with reference to FIGS. 3-5, one of ordinary skill in the art would understand that the exemplary embodiments illustrate the principles of the invention, and are not intended to limiting.

In the embodiments of FIGS. 3-5, a center conductor 10 is adapted for use in, for example, a coaxial RF Jack connector 100 having an insulating sleeve 20, and being surface-mounted on a PCB 200. The center conductor 10 has a contacting portion 11, a soldering portion 12 and a conductor body 13 extending therebetween and having a first end connected to the contacting portion 11 and an opposite second end connected to the soldering portion 12. The contacting portion 11 is inserted in a complimentary contacting portion receiving space of the insulating sleeve 20 of the RF Jack connector 100; the soldering portion 12 complimentary to a soldering pad 50 of the PCB 200, and in an embodiment, is soldered thereto.

In an embodiment of FIG. 3, a solder receiving groove 121 is formed as crossed grooves in an end surface of the soldering portion 12. The two crossed solder receiving grooves 121 orthogonally extend in two diametrical directions across the end surface of the soldering portion 12. In an embodiment, each of the solder receiving grooves 121 has a width in a range of approximately 0.10-0.20 mm. In an embodiment, each of the solder receiving grooves 121 has a width of approximately 0.15 mm. During reflow soldering of the soldering portion 12 onto the soldering pad 50 of the PCB 200, the solder receiving grooves 121 draw excess amounts of solder, such as Tin fillet. As such, the soldering process can be controlled and the outside dimension of the center conductor can be maintained with no overflowed solder.

In an embodiment, the solder receiving groove 121 are formed as a centered recess at the end surface of the soldering portion 12, rather than as two crossed solder receiving grooves, so long as the excess amount of solder during reflow soldering can be completely drawn into the centered recess, ensuring the soldering process remains controlled. In an embodiment, the solder receiving groove 121 may also be formed as one or more grooves extending along a diametrical direction of the soldering portion 12.

In an embodiment of FIG. 4, an RF Jack connector 100 includes the center conductor 10, the insulating sleeve 20, and a shielding shell 30 that serves as an electrical ground return. The insulating sleeve 20 is inserted into the complimentary contacting portion receiving space of the shielding shell 30 from the base thereof, and a center conductor 10 being inserted into the complimentary central insertion bore thereof (not shown) from the base of the insulating sleeve 20. With such an arrangement, all the advantages of the center conductor 10 can be found in the RF Jack connector 100.

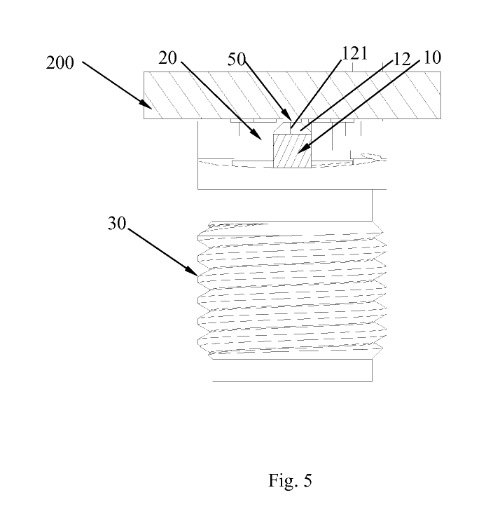

In an embodiment of FIG. 5, the soldering portion 12 of the center conductor 10 is formed in a shape of a cone, that is, the soldering portion 12 tapers away from the cylindrical conductor body 13. In an embodiment, an outer diameter of the conductor body 13 is approximately 1.27 mm. In an embodiment, a conductor body connecting end (not labeled) of the soldering portion 12, positioned proximate to the conductor body 13, has an outer diameter of approximately 1.27 mm. In an embodiment, an opposite terminating end of the soldering portion 12, positioned distal to the conductor body 13, has an outer diameter of approximately 0.6 mm. Correspondingly, the diameter of the soldering pad 50 of the PCB 200 may be decreased to minimum, such as approximately 0.6 mm. With this arrangement, the center conductor 10 permits the soldering pad to be reduced in size over conventional center conductors, allowing the PCB can be made more compact. Moreover, the cone shape of the soldering portion 12 improves the impedance continuity at the soldering point, resulting in improved VSWR at high frequencies.

Those ordinary skilled in the art would understand and appreciate that modifications may be made to the disclosed embodiments which do not depart from the spirit of the invention. Such modifications are intended to be included within the scope of the appended claims. For example, it is possible to utilize the above center conductor 10 in other surface-mounted connectors.

What is claimed is:

1. A center conductor for a surface-mounted electrical connector, comprising:
a contacting portion complimentary to a contacting portion receiving space of an insulating sleeve of the electrical connector;
a conductor body having a first end connected to the contacting portion; and
a soldering portion connected to an opposite second end of the conductor body, having a first solder receiving groove formed on an end surface thereof, and being complimentary to a soldering pad of a printed circuit board.

2. The center conductor of claim 1, further comprising a second solder receiving groove.

3. The center conductor of claim 2, wherein the first and second solder receiving grooves orthogonally extend in two diametrical directions.

4. The center conductor of claim 3, wherein each of the solder receiving grooves has a width in a range of approximately 0.10-0.20 mm.

5. The center conductor of claim 4, wherein each of the solder receiving grooves has a width of approximately 0.15 mm.

6. The center conductor of claim 1, wherein the solder receiving groove is formed as a center recess.

7. The center conductor of claim 1, wherein the soldering portion is cone shaped.

8. A surface-mounting electrical connector, comprising:
an insulating sleeve having a central insertion bore with a center conductor receiving opening on a base side;
a cylindrical shielding shell serving as an electrical ground return, and into which the insulating sleeve is positioned; and
a center conductor being partially positioned in the central insertion bore of the insulating sleeve through the center conductor receiving opening, and having
a contacting portion complimentary to the central insertion bore and being positioned therein,
a conductor body having a first end connected to the contacting portion, and
a soldering portion connected to an opposite second end of the conductor body and extending out of the insulating sleeve, having a first solder receiving groove formed on an end surface thereof, and being complimentary to a soldering pad of a printed circuit board.

9. The electrical connector of claim 8, wherein the center conductor further comprises a second solder receiving groove.

10. The electrical connector of claim 9, wherein the first and second solder receiving grooves orthogonally extend in two diametrical directions.

11. The electrical connector of claim 10, wherein each of the solder receiving grooves has a width in a range of approximately 0.10-0.20 mm.

12. The electrical connector of claim 11, wherein each of the solder receiving grooves has a width of approximately 0.15 mm.

13. The electrical connector of claim 8, wherein the solder receiving groove is a center recess.

14. The electrical connector of claim 8, wherein the soldering portion is cone shaped.
